(19) United States
(12) Patent Application Publication
(10) Pub. No.: US 2025/0146829 A1
(43) Pub. Date: May 8, 2025

(54) APPARATUS AND METHOD FOR SEARCHING FOR A ROUTE USING ETA PREDICTION BASED ON A GRAPH NEURAL NETWORK

(71) Applicant: HYUNDAI AUTOEVER CORP., Seoul (KR)

(72) Inventors: Sangkyu Son, Seoul (KR); AhYoung Kang, Seoul (KR); Ruda Rhee, Seoul (KR)

(73) Assignee: HYUNDAI AUTOEVER CORP., Seoul (KR)

(21) Appl. No.: 18/934,790

(22) Filed: Nov. 1, 2024

(30) Foreign Application Priority Data
Nov. 6, 2023 (KR) 10-2023-0152060

(51) Int. Cl. G01C 21/34

(52) U.S. Cl. CPC G01C 21/3492

(57) ABSTRACT

An apparatus and a method for searching for a route using estimated time of arrival (ETA) prediction based on a graph neural network are provided. The apparatus includes a storage module configured to store digital map data. The apparatus includes a processor configured to perform a route search based on an ETA prediction model according to a route exploration request. The ETA prediction model is generated based on a graph neural network formed by converting road information into a graph.

### CROSS-REFERENCE TO RELATED APPLICATION

This application claims the priority to and the benefit of Korean Patent Application No. 10-2023-0152060, filed on Nov. 6, 2023, the entire contents of which are incorporated herein by reference.

### TECHNICAL FIELD

The present disclosure relates to an apparatus and a method for searching for a route using an estimated time of arrival (ETA) prediction based on a graph neural network. More particularly, the present disclosure relates to an apparatus and a method for searching for a route that perform a route search by expressing a road network as a graph neural network and utilizing the road network to predict an ETA.

### BACKGROUND

Recently, because most vehicles are equipped with navigation devices, and due to an increase of vehicles, vehicle congestion frequently occurs on roads and intersections. Even when users drive on a road that the users already know, it is common to perform a route search in advance through a navigation device and receive guidance so that sections such as roads or intersections where congestion occurs can be identified in advance and avoided.

In addition, when searching for a route, the users often use estimated time of arrival (ETA) information. For example, a departure time or appointment time is determined based on the ETA information. Therefore, when the ETA information is not accurate, the user adds an extra time to determine the departure time or appointment time. By contrast, when the ETA information is accurate, the extra time can be reduced so that the user can save a time without wasting a time on the road.

Thus, in a route search process of navigation, an optimal route, a recommended route, and the like are calculated by utilizing the ETA information.

Meanwhile, because deep learning-based information prediction technology develops, research on deep learning-based technology for more accurately predicting an estimated time of arrival is actively being conducted.

Therefore, an efficient technique is required for expressing road data so as to allow the road data to be used as an input of a deep learning model. The subject matter described in this background section is intended to promote an understanding of the background of the disclosure and thus may include subject matter that is not already known to those of ordinary skill in the art.

### SUMMARY

The present disclosure provides an apparatus and a method for searching for a route using estimated time of arrival (ETA) prediction based on a graph neural network that expresses a road network as a graph neural network to enable ETA prediction.

An apparatus for searching for a route using estimated time of arrival (ETA) prediction based on a graph neural network according to the present disclosure includes a storage module configured to store digital map data. The apparatus also includes a processor configured to perform a route search based on an ETA prediction model according to a route exploration request. The ETA prediction model is generated based on a graph neural network formed by converting road information into a graph.

According to an embodiment of the present disclosure, the ETA prediction model may be generated by converting a link of road information into a node of a graph and converting connectivity between links into edges of the graph.

In the present disclosure, the ETA prediction model may be generated based on a graph neural network including features of the entire route as global attributes.

According to an embodiment of the present disclosure, the node attribute of the graph may include information on a past speed or a passage time of a link corresponding to a node of the graph.

According to an embodiment of the present disclosure, a weight may predict a value that is greater than a predicted value that is smaller than a correct answer. The weight may be applied to the ETA prediction model.

According to an embodiment of the present disclosure, a weight may increase an influence of a preset time zone on an output value of the ETA prediction model. The weight may be applied to the ETA prediction model.

According to an embodiment of the present disclosure, the processor may compute a plurality of candidate routes according to the route search request and may compute an ETA of each candidate route through the ETA prediction model.

According to an embodiment of the present disclosure, the processor may compute a cost of each candidate route based on the computed ETA of each candidate route.

A method of generating an estimated time of arrival (ETA) prediction model according to the present disclosure includes: converting, by a processor, links of road information into nodes and converting connectivity between the links into edges of a graph to convert the road information into the graph. The method also includes inserting, by the processor, related data into a global attribute of the graph, a node attribute of the graph, and an edge attribute of the graph. The method also includes learning, by the processor, an ETA prediction model by using the global attribute of the graph, the node attribute of the graph, and the edge attribute of the graph as input values.

According to an embodiment of the present disclosure, the global attribute of the graph may include past ETA information for a route. The node attribute of the graph may include information on a past speed or a passage time of a link corresponding to a node of the graph. The edge attribute of the graph may include information on connectivity between the nodes and information on whether a road type is changed.

According to an embodiment of the present disclosure, the method may further include outputting, by the ETA prediction model, a link passage time as an output value.

According to an embodiment of the present disclosure, the method may further include outputting, by the ETA prediction model, ETA values for a route.

A method for searching for a route using estimated time of arrival (ETA) prediction based on a graph neural network according to the present disclosure includes receiving, by a processor, a route search request. The method also includes performing, by the processor, route search based on an ETA prediction model. The method also includes providing, the processor, a route search result. The ETA prediction model is generated based on a graph neural network formed by converting road information into a graph.

According to an embodiment of the present disclosure, performing the route search may further include computing, by the processor, a plurality of candidate routes in response to the route search request. Performing the route search may further include computing, by the processor, an ETA of each candidate route through the ETA prediction model.

According to an embodiment of the present disclosure, performing the route search may further include computing, by the processor, a cost of each candidate route based on the computed ETA of each candidate route.

According to an embodiment of the present disclosure, computing the ETA of each candidate route through the ETA prediction model may include converting, by the processor, each candidate route into a respective graph by converting links of the candidate routes into nodes of the graph and by converting connectivity between the links into edges of the graph. Computing the ETA of each candidate route through the ETA prediction model may also include calculating, by the processor, an ETA of each candidate route through the ETA prediction model by inputting data related to a global attribute of the graph, a node attribute of the graph, and an edge attribute of the graph as input values.

According to an embodiment of the present disclosure, the global attribute of the graph may include past ETA information on the route. The node attribute of the graph may include information on a past speed or a passage time of a link corresponding to a node of the graph. The edge attribute of the graph may include information on connectivity between the nodes and information on whether a road type is changed.

According to an embodiment of the present disclosure, the method may also include predicting, by a weight, a value that is greater than a predicted value that is smaller than a correct answer. The method may also include applying the weight to the ETA prediction model.

According to an embodiment of the present disclosure, the method may also include increasing, by a weight, an influence of a preset time zone on an output value of the ETA prediction model. The method may also include applying the weight to the ETA prediction model.

### BRIEF DESCRIPTION OF THE DRAWINGS

FIG. 1 is a diagram illustrating a schematic configuration of an apparatus for searching for a route using estimated time of arrival (ETA) prediction based on a graph neural network according to one embodiment of the present disclosure.

FIGS. 2 and 3 are diagrams for describing a graph transformation method of the apparatus for searching for a route using ETA prediction based on a graph neural network according to one embodiment of the present disclosure.

FIG. 4 is a diagram for describing an ETA prediction model of the apparatus for searching for a route using ETA prediction based on a graph neural network according to one embodiment of the present disclosure.

FIG. 5 is a flowchart for describing a method of searching for a route using ETA prediction based on a graph neural network according to one embodiment of the present disclosure.

FIG. 6 is a flowchart for describing utilization of an ETA prediction model in the method of searching for a route using ETA prediction based on a graph neural network according to one embodiment of the present disclosure.

FIG. 7 is a flowchart for describing an ETA prediction operation of the method of searching for a route using ETA prediction based on a graph neural network according to one embodiment of the present disclosure.

### DETAILED DESCRIPTION

Embodiments of an apparatus and a method for searching for a route using estimated time of arrival (ETA) prediction based on a graph neural network according to the present disclosure are described hereinafter with reference to the accompanying drawings. The thickness of lines and the size of components illustrated in the drawings may be exaggerated for clarity and convenience of description. In addition, the terms used below are defined in consideration of the functions thereof in the present disclosure and may vary based on the intention of a user or an operator or common practice. Therefore, these terms should be contextually defined in light of the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

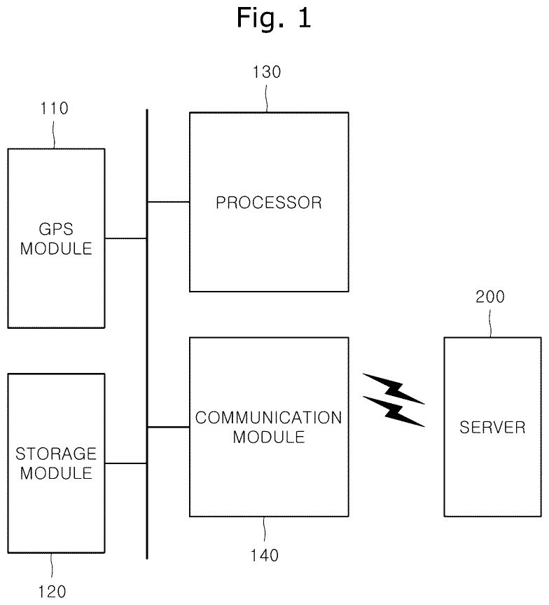

FIG. 1 is a diagram illustrating a schematic configuration of an apparatus for searching for a route using ETA prediction based on a graph neural network according to one embodiment of the present disclosure.

As shown in FIG. 1, the apparatus for searching for a route using ETA prediction based on a graph neural network according to the present embodiment includes a global positioning system (GPS) module 110, a storage module 120, a processor 130, and a communication module 140.

The GPS module 110 receives a GPS signal for detect a current position of a vehicle and also receives current position information of a navigation device using a GPS module.

In addition, the GPS module 110 may receive traffic (traffic volume) information and vehicle traffic volume information for each link, lane information for each road, and traffic situation information (e.g., accident information, event information, construction information, and the like) through a real-time traffic information reception module or the communication module 140.

An internal memory (or database) of the processor 130 stores digital map data (e.g., precision map data, a high definition (HD) map, and the like), and the digital map data includes geographic coordinates indicating latitude and longitude in units of degrees/minutes/seconds.

The storage module 120 may store link information based on the digital map data and may store a traffic information history for each link, which is received through the communication module 140.

The storage module 120 may store a real-time traffic information history for each link in units of seasons, days, and times.

In this case, the storage module 120 may store the real-time traffic information history for each link in the server 200 or may store the real-time traffic information history for a certain period of time (e.g., a designated period of time, i.e., one year) by interlocking with the server 200.

Therefore, the information stored in the storage module 120 below should be understood as including the information stored in the server 200.

The processor 130 may learn, for example, perform deep learning, by reflecting the information stored in the storage module 120 (e.g., the real-time traffic information for each link and information on road properties (e.g., the number of lanes, the presence of signals, the number of turns, collection trajectory, the traffic information history, and the like)).

The processor 130 is a concept that includes a path search engine (e.g., a path search algorithm) and an ETA prediction model (e.g., a deep learning model for ETA prediction).

The processor 130 may compute (calculate) a plurality of candidate routes through the route search engine and compute (calculate) an optimal route among the candidate routes through the ETA prediction model.

The processor 130 may compute a more accurate optimal route during route search through an ETA prediction model based on a graph neural network.

The communication module 140 communicates with the server 200 (e.g., an ETA prediction server, a cloud server, a navigation server, and the like).

The apparatus for searching for a route using ETA prediction based on a graph neural network according to the present embodiment includes a navigation terminal installed in the vehicle and at least one external server 200 connected to the navigation terminal through communication (e.g., a navigation server, a cloud server, an ETA prediction server, and the like).

For example, when communicably connected to the server 200, the apparatus for searching for a route using ETA prediction based on a graph neural network according to the present embodiment may compute (calculate) a plurality of candidate paths and guide an optimal route (i.e., an optimal candidate path with the lowest cost) among the plurality of candidate paths using one or more pieces of information provided to or from the server 200 (e.g. the real-time traffic information, the ETA prediction information, cost information, and the like).

Alternatively, in some embodiments, the server 200 may be configured to receive a route search request from a navigation terminal installed in the vehicle, may compute an optimal route by reflecting the ETA for a corresponding route, and then may provide the optimal route to the navigation terminal.

In addition, because the server 200 is also equipped with a computing device such as a processor to perform the above route search operation, it can be described as the route search operation by the server 200 is performed by a processor.

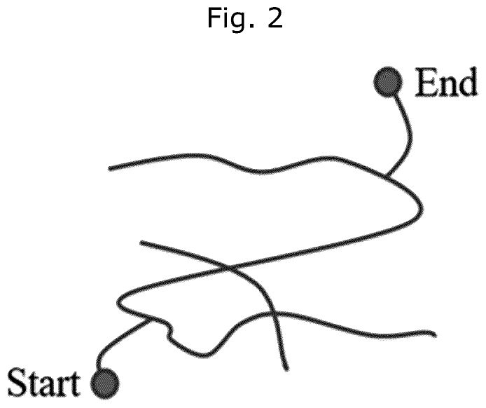

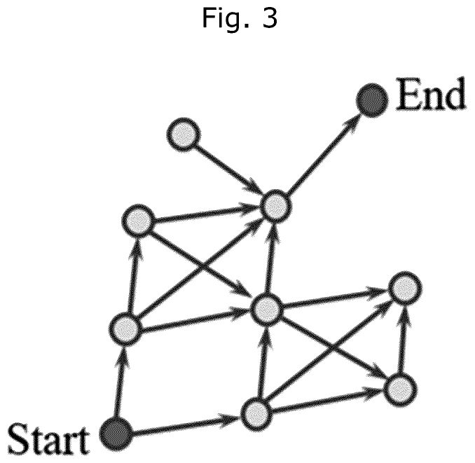

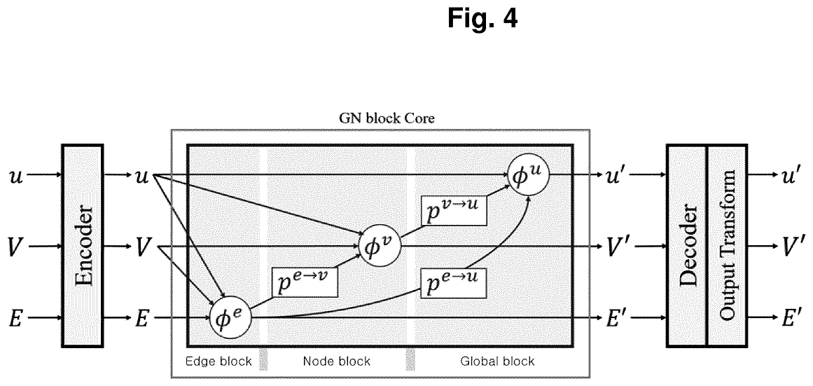

FIGS. 2 and 3 are diagrams for describing a graph transformation method of the apparatus for searching for a route using ETA prediction based on a graph neural network according to one embodiment of the present disclosure. FIG. 4 is a diagram for describing an ETA prediction model of the apparatus for searching for a route using ETA prediction based on a graph neural network according to one embodiment of the present disclosure.

The ETA prediction model in the apparatus for searching for a route using ETA prediction based on a graph neural network according to the present disclosure utilizes a graph neural network, and the graph neural network is a deep learning model that learns data of a graph structure. By learning connectivity between the data and a topological structure of the data, embedding that express an attribute of a graph may be generated.

The graph has a combinatorial structure with node and edge attributes, and when two nodes are adjacent to each other, connectivity between the nodes is expressed as an edge. When directivity of the edge is present, it is referred to as a directed graph.

Meanwhile, road information may generally comprise nodes and links, nodes refer to road nodal points (e.g., intersections), and links refer to road lines connecting these nodes.

Therefore, as shown in FIGS. 2 and 3, road information may be converted into a graph by expressing the links constituting the road as nodes of the graph and expressing the connectivity and changing information between the links as edges.

The graph used in the present disclosure may be a directed graph including global properties representing the graph itself.

In this case, the features of the entire route may be expressed globally.

Thus, when node, edge, and global attributes are represented as V, E, and u, respectively, a graph with the attributes V, E, and u may be represented as G(V, E, u).

In addition, the graph represents the directionality of edges as sender/receiver nodes according to a road travel direction. The sender node may include information on a departure link, and the receiver node may include information on an arrival link.

The node attribute of the graph may include data, such as a link attribute, a past speed of a corresponding link (e.g., a speed over the past 40 minutes), and a link passage time. The edge attribute of the graph may include data such as the connectivity between the nodes and whether a road type is changed. The global attribute may include data such as past ETA information on the corresponding route (e.g., ETA information over the past 40 minutes), day of week information (weekday and weekend), and accident information (crash and construction).

As shown in FIG. 4, according to the present disclosure, a road network is expressed as data of a graph structure to generate an ETA prediction model based on a graph neural network. In particular, a graph network (GN) block structure is used to enable application of not only a spatial feature of the road network but also a temporal feature of the road network. Therefore, the ETA prediction model according to the present disclosure has an advantage of reflecting complex road network features and minimizing spatio-temporal data loss.

Referring to FIG. 4, the ETA prediction model structure according to the present disclosure is a GN block-based structure. This allows learning about a relationship between a node block, an edge block, and a global block.

Features of the GN block-based structure are feature propagation, feature transformation, and feature aggregation. The feature propagation propagates the features of nodes and edges to model interactions between adjacent nodes and edges. The feature transformation updates the features of the nodes and the edges into new features by linearly or nonlinearly transforming the features. The feature aggregation aggregates the features of the adjacent nodes and edges to generate new features of the adjacent nodes and edges.

In the present disclosure, the model structure is designed such that the features of a predicted target link and adjacent links are reflected to the node block, the edge block, and the global block in a node block of the GN block, and then the adjacent links are excluded from learning. Thus, the predicted target link may be focused on.

In addition, a distinction value of a link and an adjacent link within a route and whether there is a change in road type may be expressed as binary values, and the binary values may be used as additional features. When the learning is performed by adding the additional features, connectivity of the edges may be emphasized.

Meanwhile, when a GN block core of FIG. 4 is repeated k times, features in a wider range of links may be reflected as k-hop (a set of nodes that can be reached through k edges from a reference node). In this case, in order to properly reflect features of various scales obtained by k times repetition, a bi-directional feature pyramid network (BIFPN) is applied to the present disclosure. The BIFPN is configured to differentiate degrees in which input features with different resolutions contribute to output features and is a technique of adding a bottom-up method to the existing top-down FPN to allow resolution information for various scales to be extracted.

In addition, with regard to a loss function, a driver tends to have lower service satisfaction when an actual arrival time exceeds an ETA. According to the present disclosure, in order to complement the above problem, a weight is applied prediction that is smaller than a correct answer during the model learning. In other words, in order to detect a change in traffic condition, weights are also applied to peak hours (e.g., 05:40 to 11:30 and 15:30 to 19:30) in which traffic is large. In other words, in the ETA prediction model according to the present disclosure, a weight may be applied so as to predict a value that is greater than a predicted value that is smaller than a correct answer, and a weight may be applied so as to increase an influence of a preset time zone on an output value of the ETA prediction model.

For example, Huber loss may be used in the present disclosure, and the Huber loss is a technique of combining an advantage of a mean squared error (MSE), which is differentiable at all points, and an advantage of a mean absolute error (MAE), which is insensitive to an abnormal value.

In addition, in the present disclosure, an exponential moving average (EMA) may be applied. The EMA is a technique of giving a high weight to recent data and giving a low weight to past data to a low influence. This technique enables learning by taking into account of trends.

Meanwhile, with respect to an output value of the ETA prediction model, in the present disclosure, both attributes for nodes and globals may be used as correct labels (target nodes and target globals). The target node refers to a node to be predicted by the model and may include link passage time information for up to future 30 minutes in a unit of 5 minutes. The target global refers to a global to be predicted by the mode and may include ETA information of the entire route for up to future 30 minutes in a unit of 5 minutes.

As the same as a learning process of a general deep learning model, the learning process is performed to infer a result value using an initial artificial intelligence (AI) model based on the above-described input values (the global, node, and edge attributes), derive an error value between the inferred value and the correct value (label value) through a loss function, and perform AI model learning (parameter update) based on the derived error value.

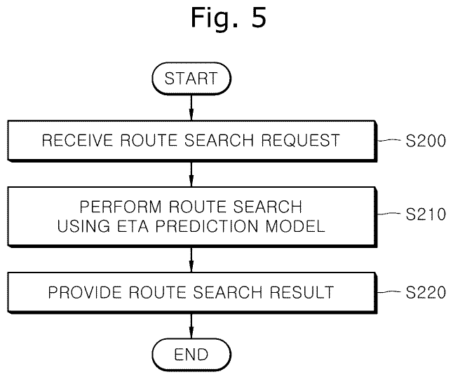

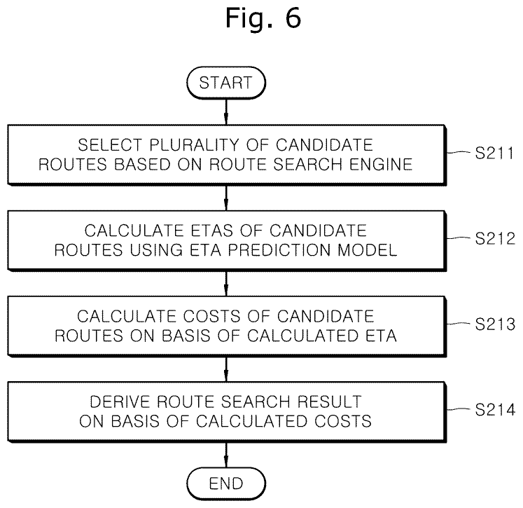

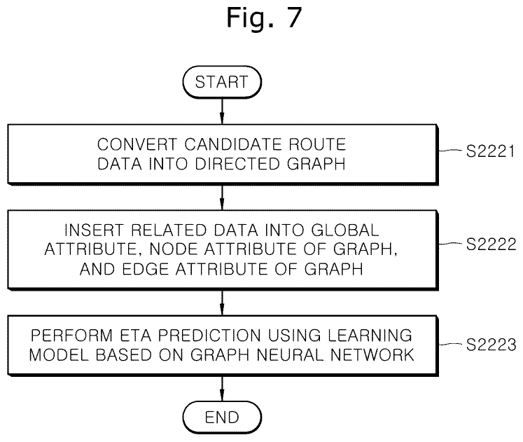

FIG. 5 is a flowchart for describing a method of searching for a route using ETA prediction based on a graph neural network according to one embodiment of the present disclosure, FIG. 6 is a flowchart for describing utilization of an ETA prediction model in the method of searching for a route using ETA prediction based on a graph neural network according to one embodiment of the present disclosure and FIG. 7 is a flowchart for describing an ETA prediction operation of the method of searching for a route using ETA prediction based on a graph neural network according to one embodiment of the present disclosure.

As shown in FIG. 5, the processor 130 receives a route search request (S200). For example, the processor 130 may receive a route search request including departure point information, destination information, and departure time information from a user through an input module of a navigation device.

Then, the processor 130 performs route search using the ETA prediction model (S210).

An operation of the route search is generally performed based on a route search engine. The route search engine may search for a route from a departure point to a destination based on information such as the departure point information, the destination information, and the departure time information and may select and output a candidate route suitable for various conditions (e.g., a shortest distance, a shortest time, a priority on toll-free roads). However, because the route search engine is a technology widely used already in the technical field of the present disclosure, a detailed description thereof has been omitted herein.

Accordingly, as shown in FIG. 6, the processor 130 selects a plurality of candidate routes based on the route search engine (S211). In this case, the route search engine may use a method of selecting the candidate routes by calculating a cost for each link and calculating the candidate routes in a low order of the summed cost. Here, a cost of the link is a concept of quantifying a cost used to pass through the link and may be calculated by considering a length of the link and an expected passage time of the link. In addition, an ETA of a candidate route may be predicted and reflected to the cost to calculate a final cost of the corresponding route.

However, a specific calculation method of the cost of a navigation route may vary based on an intent of a user and design of a navigation system.

In this case, because the route search engine often utilizes the ETA even in calculating the candidate routes, in some embodiments, the route search engine may be configured to include the above-described ETA prediction model according to the embodiment of the present disclosure to calculate the candidate routes.

Alternatively, as described below, the route search engine may select a candidate route according to the existing method but may employ a method of re-estimating a cost by additionally performing ETA prediction using the above-described ETA prediction model according to the embodiment of the present disclosure.

Accordingly, the processor 130 calculates ETAs of the candidate routes using the above-described ETA prediction model according to the embodiment of the present disclosure (S212).

For example, as shown in FIG. 7, the processor 130 converts candidate route data into a directed graph (S2221). In other words, the candidate route may be converted into the directed graph by expressing links constituting the candidate routes as nodes of the graph and expressing connectivity and changing information between the links as edges.

Thereafter, the processor 130 inserts related data into the global attribute, the node attribute of the graph, and the edge attribute of the graph (S2222) and then performs ETA prediction using a learning model based on a graph neural network (S2223). In other words, the ETA prediction may be performed by inputting data related to the candidate routes in the same manner as an attribute data input for learning in FIG. 4.

As described above, an ETA prediction model output value may be an ETA value and/or a link passage time for the entire route. In other words, the ETA value for the entire route may be predicted directly, or the passage time of each link of the entire route may be predicted. In the latter case, a sum value of the link passage times may be used as the ETA prediction value.

Subsequently, the processor 130 calculates costs of the candidate routes based on the calculated ETA (S213).

Thereafter, the processor 130 derives a route search result based on the calculated costs (S214). In other words, the processor 130 may recalculate and sort costs based on the ETAs of the estimated candidate routes to sort the candidate routes in order of a low (small) cost.

Subsequently, the processor 130 provides the route search result (S220). In other words, the processor 130 may provide the user with a list of the candidate routes and the ETAs thereof as the route search result.

According to an apparatus and a method for searching for a route using estimated time of arrival (ETA) prediction based on a graph neural network of the present disclosure, there is an effect of increasing efficiency of a time and resource utilization by providing accurate ETA information to a driver by expressing a road network as a graph neural network to predict an ETA.

In addition, the apparatus and a method for searching for a route using ETA prediction based on a graph neural network and the method according to the present disclosure may provide an effect of sensitively detecting a change in peak hour traffic information (speed) by applying a weight in relation to ETA prediction and improving service satisfaction felt by a driver regarding the ETA prediction.

While the present disclosure has been described with reference to the embodiments shown in the drawings, these embodiments are merely illustrative and it should be understood that various modifications and equivalent other embodiments can be derived by those having ordinary skill in the art based on the embodiments. Therefore, the technical scope of the present disclosure should be defined by the appended claims.

What is claimed is:

1. An apparatus for searching for a route using estimated time of arrival (ETA) prediction based on a graph neural network, the apparatus comprising:
a storage module configured to store digital map data; and
a processor configured to perform a route search based on an ETA prediction model according to a route exploration request,
wherein the ETA prediction model is generated based on a graph neural network formed by converting road information into a graph.

2. The apparatus of claim 1, wherein the ETA prediction model is generated by converting a link of road information into a node of a graph and converting connectivity between links into edges of the graph.

3. The apparatus of claim 2, wherein the ETA prediction model is generated based on a graph neural network including features of the route as global attributes.

4. The apparatus of claim 2, wherein a feature of the node of the graph includes information on a past speed or a passage time of a link corresponding to a node of the graph.

5. The apparatus of claim 1, wherein a weight configured to predict a value that is greater than a predicted value that is smaller than a correct answer, and
wherein the weight is configured to be applied to the ETA prediction model.

6. The apparatus of claim 1, wherein a weight is configured to increase an influence of a preset time zone on an output value of the ETA prediction model, and
wherein the weight is configured to be applied to the ETA prediction model.

7. The apparatus of claim 1, wherein the processor is further configured to:
compute a plurality of candidate routes according to a route search request; and
compute an ETA of each candidate route through the ETA prediction model.

8. The apparatus of claim 7, wherein the processor is further configured to compute a cost of each candidate route based on the computed ETA of each candidate route.

9. A method of generating an estimated time of arrival (ETA) prediction model, the method comprising:
converting, by a processor, links of road information into nodes and converting connectivity between the links into edges of a graph to convert the road information into the graph;
inserting, by the processor, related data into a global attribute of the graph, a node attribute of the graph, and an edge attribute of the graph; and
learning, by the processor, an ETA prediction model by using the global attribute of the graph, the node attribute of the graph, and the edge attribute of the graph as input values.

10. The method of claim 9, wherein:
the global attribute of the graph includes past ETA information for a route;
the node attribute of the graph includes information on a past speed or a passage time of a link corresponding to a node of the graph; and
the edge attribute of the graph includes information on connectivity between the nodes and information on whether a road type is changed.

11. The method of claim 9, further comprising:
outputting, by the ETA prediction model, a link passage time as an output value.

12. The method of claim 9, further comprising:
outputting, by the ETA prediction model, ETA values for a route.

13. A method of searching for a route using estimated time of arrival (ETA) prediction based on a graph neural network, the method comprising:
receiving, by a processor, a route search request;
performing, by the processor, route search based on an ETA prediction model; and
providing, the processor, a route search result,
wherein the ETA prediction model is generated based on a graph neural network formed by converting road information into a graph.

14. The method of claim 13, wherein performing the route search includes:
computing, by the processor, a plurality of candidate routes in response to the route search request; and
computing, by the processor, an ETA of each candidate route through the ETA prediction model.

15. The method of claim 14, wherein performing the route search further includes computing, by the processor, a cost of each candidate route based on the computed ETA of each candidate route.

16. The method of claim 14, wherein computing the ETA of each candidate route through the ETA prediction model includes:
converting, by the processor, each candidate route into a respective graph by converting links of the candidate routes into nodes of the graph and by converting connectivity between the links into edges of the graph; and
calculating, by the processor, an ETA of each candidate route through the ETA prediction model by inputting data related to a global attribute of the graph, a node attribute of the graph, and an edge attribute of the graph as input values.

17. The method of claim 16, wherein:
the global attribute of the graph includes past ETA information on the route;
the node attribute of the graph includes information on a past speed or a passage time of a link corresponding to a node of the graph; and
the edge attribute of the graph includes information on connectivity between the nodes and information on whether a road type is changed.

18. The method of claim 14, further comprising:
predicting, by a weight, a value that is greater than a predicted value that is smaller than a correct answer; and
applying the weight to the ETA prediction model.

19. The method of claim 14, further comprising:
Increasing, by a weight, an influence of a preset time zone on an output value of the ETA prediction model; and
applying the weight to the ETA prediction model.
